(19) United States
(12) Patent Application Publication
(10) Pub. No.: US 2013/0054697 A1
(43) Pub. Date: Feb. 28, 2013

(54) SYSTEM AND METHOD FOR SHARING CONTENT USING NEAR FIELD COMMUNICATION IN A CLOUD NETWORK

(71) Applicant: Sung Hun CHA, Seoul (KR)

(72) Inventor: Sung Hun CHA, Seoul (KR)

(73) Assignee: PANTECH CO., LTD., Seoul (KR)

(21) Appl. No.: 13/590,946

(22) Filed: Aug. 21, 2012

(30) Foreign Application Priority Data
Aug. 26, 2011 (KR) 10-2011-0085807

(51) Int. Cl. G06F 15/16

(52) U.S. Cl. 709/204

(57) ABSTRACT

A content sharing system using near field communication (NFC) in a cloud network, includes: a server to store contents; a first device having an authority to use the contents and generating first data including a list of shared contents among the contents and digital rights management (DRM) condition; and a second device to generate second data including a key value for identifying the second device and to transmit the second data to the first device when the NFC is activated for sharing the shared contents, wherein, in order to share the shared contents, the first device generates third data including the first data and second data. The contents may be encoded according to a device's performance criteria, and the sharing of the shared contents may be restricted according to location or distance.

### CROSS-REFERENCE TO RELATED APPLICATION

This application claims priority from and the benefit of Korean Patent Application No. 10-2011-0085807, filed on Aug. 26, 2011, which is incorporated by reference for all purposes as if fully set forth herein.

### BACKGROUND

1. Field

The following description relates to a system and method for sharing content, and in particular, to a system and method for sharing content using near field communication (NFC) in a cloud network.

2. Discussion of the Background

Generally, a process or operation may be performed on a personal computer and other terminals to view personal or private data on a website. In addition, if a user is willing to share certain contents with another person, a series of processes may be performed, such as those depicted in FIG. 1.

FIG. 1 depicts various terminal screens during a conventional content sharing process. Referring to FIG. 1, on screen (a), a user may click and hold down (i.e., “long click”) a content (for example, a uniform resource locator (URL) of the content) to be shared to activate a corresponding pop-up box. On screen (b), an application program to be used in sharing (or application to be shared) is selected. In screen (b) of FIG. 1, if “message” application is selected to share the content, in screen (c), the URL of the content to be shared is automatically inserted into a message application, along with additional information that may be added thereto and transmitted. In screen (d), a message may be received in the terminal of a recipient user. In screen (e), a pop-up box is activated if the corresponding content is touched. The pop-up box may allow a user to select a web application to activate. As a result, in screen (f), a user may select the URL hyperlink to connect to content corresponding to the specified URL.

Personal information such as a user identification (ID), password, and a URL of a corresponding website may be exchanged verbally, in an email, or text message in order to share content between terminals. This may increase the risk of exposure of the personal information. Furthermore, by exchanging personal information verbally, in an email, or in a text message, an authority to access contents by a user may not be adjusted, and the content may be shared, as well as the personal information of the user, with a third party without a permission of the user. Further, personal data stored on the web may not be actively shared by users because of the risks of the exposure of the personal information to unauthorized persons.

Recently, users transition to a cloud network or a cloud computing system and as the number and kinds of information technology (IT) devices possessed by users increases and more contents are exchanged between users, there remains a desire to share content between users or different devices.

According to the conventional art, a device used to share contents may not adjust the authority to access the contents according to users who are granted access to the contents. According to the conventional art, any user may share the authority to access contents with a third party without permission of an initial user. In addition, as the kind of terminals (for example, in resolution, performance, or the like) diversifies, the contents encoded in a server may not properly regenerate according to various terminal properties.

### SUMMARY

Exemplary embodiments of the present invention provide a system and method for sharing a content using near field communication.

Additional features of the invention will be set forth in the description which follows, and in part will be apparent from the description, or may be learned by practice of the invention.

An exemplary embodiment of the present invention discloses a content sharing system using near field communication (NFC) in a cloud network, including: a server to store contents; a first device having an authority to use the contents and to generate first data including a list of shared contents among the contents and digital rights management (DRM)-associated information; and a second device to generate second data including a key value to identify the second device and to transmit the second data to the first device if the NFC is activated to share the shared contents, wherein, in order to share the shared contents, the first device generates third data including the first data and the second data.

An exemplary embodiment of the present invention also discloses a content sharing method using near field communication (NFC) in a cloud network, including: generating first data including a list of shared contents and digital rights management (DRM)-associated information in a first device; generating second data including a key value in a second device, and transmitting the second data to the first device if near field communication (NFC) is activated; and generating third data including the first data and the second data in the first device to share the shared contents.

An exemplary embodiment of the present invention also discloses a terminal to share content using near field communication (NFC) in a cloud network; including: a control unit to generate first data including a list of shared contents in a server, digital rights management (DRM)-associated information of the shared contents, and third data; and a near field communication (NFC) unit to transmit data and to receive second data, wherein the control unit generates the third data according to the first data and the second data and the NFC unit transmits the third data to the server.

It is to be understood that both the foregoing general description and the following detailed description are exemplary and explanatory and are intended to provide further explanation of the invention as claimed. Other features and aspects will be apparent from the following detailed description, the drawings, and the claims.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 illustrates various terminal screens during a conventional content sharing process.

FIG. 2 illustrates a content sharing system according to an exemplary embodiment of the present disclosure.

FIG. 3 is a diagram illustrating a data structure according to an exemplary embodiment of the present disclosure.

FIG. 4 is a flowchart illustrating a method for content sharing according to an exemplary embodiment of the present disclosure.

### DETAILED DESCRIPTION OF THE ILLUSTRATED EMBODIMENTS

Exemplary embodiments now will be described more fully hereinafter with reference to the accompanying drawings, in which exemplary embodiments are shown. This invention may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art. In the description, details of well-known features and techniques may be omitted to avoid unnecessarily obscuring the presented embodiments.

The terminology used herein is for the purpose of describing particular embodiments only and is not intended to be limiting of the present disclosure. As used herein, the singular forms “a,” “an,” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first,” “second,” and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, like reference numerals denote like elements. The shape, size and regions, and the like, of the drawing may be exaggerated for clarity. It will be understood that for the purposes of this disclosure, “at least one of X, Y, and Z” can be construed as X only, Y only, Z only, or any combination of two or more items X, Y, and Z (e.g., XYZ, XYY, YZ, ZZ).

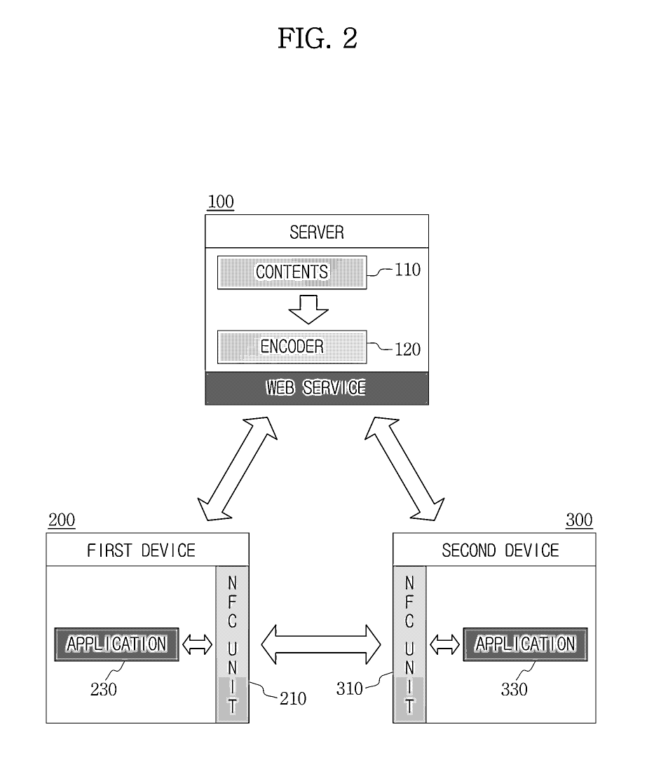

FIG. 2 illustrates a content sharing system according to an exemplary embodiment of the present disclosure.

Referring to FIG. 2, a content sharing system using near field communication (NFC) in a cloud network includes a first device 200, a second device 300, and a server 100. The first device 200 may share contents 110 stored in a server 100 with the second device 300. The contents 110 may be various kinds of data such as texts, pictures, images, etc., stored in the server 100 in a cloud network. The first device 200 may be authorized to use the content 110, and may generate first data including a list of content to be shared with the second device 300 from among the contents 110 and information associated with digital rights management (DRM).

The second device 300 may transmit second data including a key value to the first device 200 using NFC. Key value may include a password, an identification number, other identification information, and the like. The second data may further include a profile of the second device 300. The profile may include data specifying a resolution, performance information, and the like of the second device 300. The first device 200 includes an NFC unit 210 and the second device 300 includes an NFC unit 310 to perform near field communication. The first device may include a memory to store data and a control unit to generate first data. Application 230 and application 330 may be application programs to input and output data through the NFC unit 210 and NFC unit 310, respectively, and may generate a key value from terminal information, which may be unique, and may decode DRM contents, such as, image data or audio data, based on a reference key value corresponding to the generated key value. Terminal information may be information about a device that is used to identify the device or other terminal information that is unique to or associated with a device. The application 230 and application 330 may be or include one or more various user interfaces (UI) presented to a user. The key value may be generated and decoded by the application 330 of the second device 300. The application 330 may request shared content from the server 100. Similarly, if the first device 200 receives shared contents of the second device 300, the application 230 of the first device 200 may generate and decode a key value. The first device 200 and the second device 300 may be a device which may perform operations of the corresponding application and an NFC unit, such as smart phones, tablet computers, televisions, stereo systems, etc.

In order to share contents with the second device 300, the first device 200 may generate first data including a list of contents to be shared (hereinafter, referred to as “shared content”) from among the contents 110 stored in the server 100 and information associated with DRM (herein after “DRM-associated information”). The NFC unit 330 of the second device 300 may transmit second data including a key value to the first device 200, and may connect to the server 100 to request the shared contents. The first device 200 may generate third data including the first data and the second data, and may transmit the generated third data to the server 100. The server 100 may encode shared contents satisfying a DRM-associated condition with the key value in response to the request of the second device 300 to receive the shared contents and may transmit the shared contents to the second device 300.

The second data may also include profile information of the second device 300, such as, resolution, performance, speed, etc. If the shared contents satisfying the DRM-associated condition are encoded from among the shared contents requested by the second device 300, the server 100 may further encode the shared contents to be suitable for the profile of the second device 300. Thus, the shared contents may be encoded according to the profile of the second device 300 and transmitted to the second device 300. This may increase the diversity of terminals to which shared contents may be provided.

DRM may refer to an access control technique, which may be a kind of information protection technique used by a copyright owner or publication right owner in order to restrict illegal or non-certified use of digital media. DRM may generally be applied to creative media, such as sound sources (e.g., music) and movies. However, DRM is not limited thereto and can be applied to various other types of data. DRM may generally be used to reduce the unauthorized or illegally distribution or copying of digital media through an internet or intranet, and to allow a legal user to use the media. DRM may be a controllable system, which may allow a user to obtain a license to use content. In order to protect and manage digital rights, various information protection techniques, such as encoding, key management, and watermarking may be utilized in DRM. A user of the first device 200 may select content in the first device 200 for the application of DRM from the shared contents. The first device 200 may generate first data according to the selected DRM-associated content. The first data may include a DRM-associated condition which may include information regarding a validity of the application of DRM to the shared contents, a subsequent sharing right, an effective sharing term, an allowable regeneration time, an allowable sharing time, a shared contents related payment information, etc. Therefore, if the second device 300 requests shared contents, the server 100 may check whether the requested shared contents satisfy the DRM-associated condition and may transmit shared contents satisfying the DRM-associated condition to the second device 300.

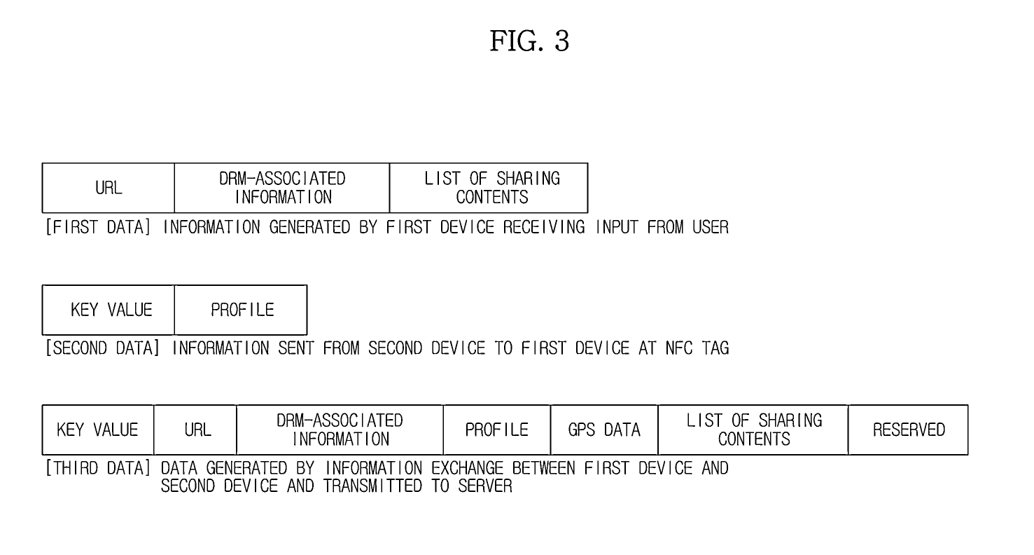

The third data may further include location data of the first device 200, such as, global positioning system (GPS) data or Wi-Fi positioning system (WPS) data. The server 100 may receive location data from the second device 300 with the request for shared contents. The server may use the location data of the first device 200 and the location data of the second device 300 to determine if the second device 300 may be allowed to receive shared content. For example, if the second device 300 is within or outside of a reference distance from the first device 200, the shared contents may be transmitted by the server 100. The second device 300 may be allowed to receive shared contents from the server 100 if the second device 300 is within the reference distance from the first device 200, i.e., if the second device 300 is separated from the first device 200 by less than or equal to the reference distance. Conversely, the second device 300 may be allowed to receive shared contents from the server 100 if the second device is outside the reference distance from the first device 200, i.e., if the second device is separated from the first device 200 by more than the reference distance. The location data of the first device 200 may include a location of the first device 200 if the first device 200 contacts the second device 300 using the NFC unit 210 and the reference distance. If the second device 300 requests shared contents, the server 100 may receive the location data of the second device 300, may analyze the location of the second device 300 and the location of the first device 200 included in the first device's location data, and may transmits the shared contents if the second device 300 is within or outside of the reference distance. The sharing of shared contents between the first device 200 and the second device 300 may be based on the third data, which may be generated by using NFC contact between the first device 200 and the second device 300. Hereinafter, the structure of the third data will be described in more detail with reference to FIG. 3.

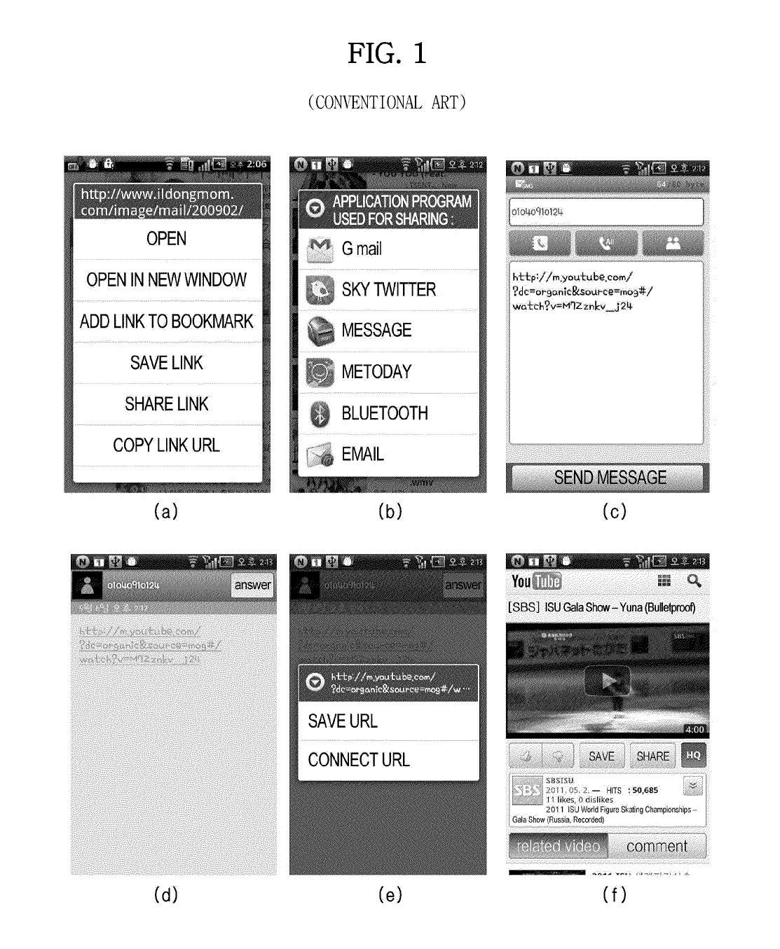

FIG. 3 is a diagram illustrating a data structure according to an embodiment of the present disclosure. The data structure will be described with reference to the system of FIG. 1, but is not limited thereto.

Referring to FIG. 3, the first data may be generated in the first device 200 in response to an input of a user. The URL refers to a uniform resource locator of the Internet, which may refer to a standardized logic address for expressing various resources such as files and new groups in the Internet. The DRM-associated information may be a reference criterion to protect a copyright of shared contents as described above and may include a DRM-associated condition which includes at least one of a validity of the application of DRM to the shared contents, a subsequent sharing right, an effective sharing term, an allowable regeneration time, an allowable sharing time, a shared contents related payment information, etc. The DRM-associated condition may be selected by a user. The list of shared contents may refer to a list of contents to be shared from among the contents 110 stored in the server 100. The second data may include unique information of the second device 300, transmitted to the first device 200 while the second device 300 contacts the first device 200 using the NFC unit 330.

The second data may include at least one of a key value and a profile. The key value may be an international mobile equipment identity (IMEI) or a mobile identification number (MIN), which may both be a unique number of the second device 300. The IMEI may refer to an identification number allocated to a mobile terminal to identify the mobile terminals in a global system for mobile communications (GSM). The MIN may refer to a number of 34 bits digitally expressing a 10-digit phone number allocated to a mobile station (e.g., a mobile telephone terminal). The key value may be used by the server 100 to encode shared contents to satisfy the DRM-associated information or to identify a device accessing the server 100. The key value may be used by the second device 300 for decoding DRM-associated information.

The profile may include at least one of a resolution, a performance criteria, etc. of the second device 300. The server 100 may encode the shared contents by using the profile. This may allow the encoded shared contents to match the resolution, and/or performance criteria of the second device 300. The third data may be data that includes the first data and the second data. The third data may further include a reserved region (i.e., Reserved) for recording additional information. The performance criteria of the second device may include at least one of a processor speed, an operating system, a software version, a memory size, a random access memory size, etc.

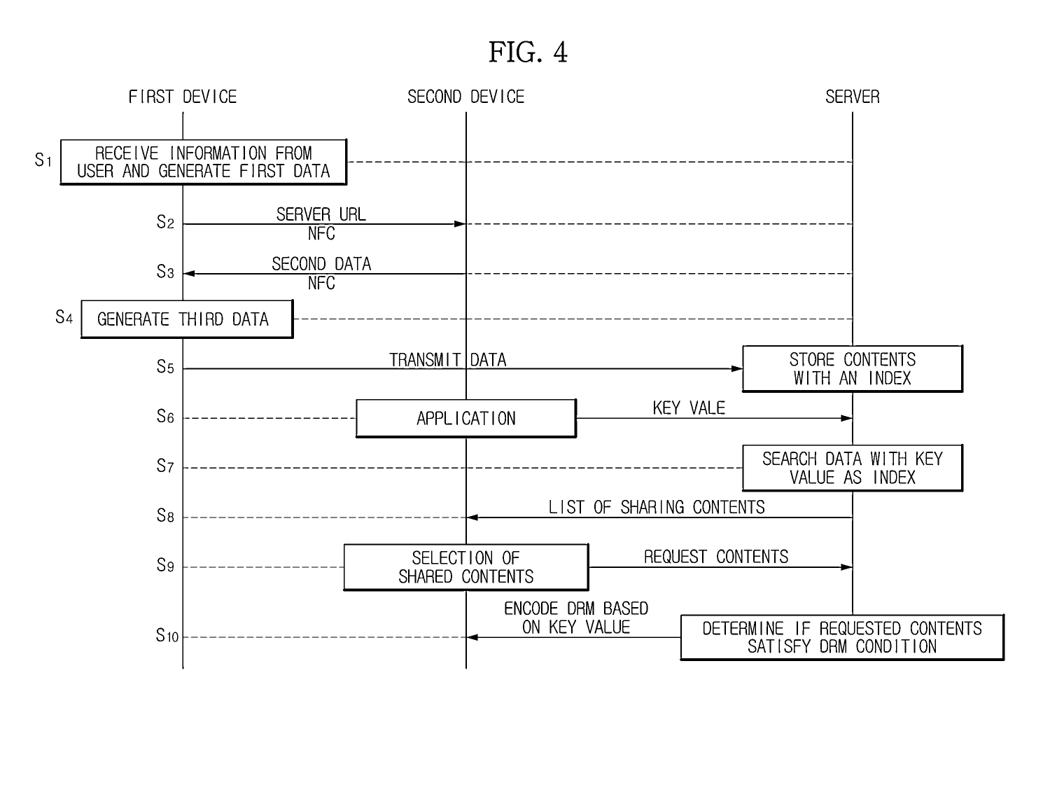

FIG. 4 is a flowchart of a method for content sharing according to an exemplary embodiment of the present disclosure. The method of FIG. 4 below will be described as if performed by the content sharing system as shown in FIG. 2, but is not limited as such.

Referring to FIG. 4, in operation S1, the first device 200 receives a list of shared contents and DRM-associated information from a user and generates first data. In operation S2, the first device 200 transmits the URL information of the server 100 to the second device 300 using NFC. In operation S3, the second device 300 transmits second data, which may include at least one of a key value and a profile of the second device 300 to the first device 200. The second device 300 may transmit the second data during NFC contact, or as a separate process. In operation S4, the first device 200 generates third data from the first data and the second data received from the second device 300. In operation S5, the first device 200 transmits the generated third data to the server 100 and the server 100 stores an index of the third data. The key value of the third data may be the index of the third data. In operation S6, if the user of the second device 300 executes an application of the second device 300, the application transmits the key value of the second device 300 to the server 100. In operation S7, the server 100 searches for third data that matches the key value received from the second device 300. In operation S8, the server 100 transmits a list of shared contents to the second device 300. In operation S9, the user may select shared contents from among the list of shared contents and the second device 300 requests the selected shared contents from the server 100. In operation S10, the server 100 determines if the selected shared contents satisfies the DRM-associated condition of the first device and if satisfied the server 100 encodes the selected shared contents according to the key value of the second device 300 and transmits the selected shared contents to the second device 300. The application of the second device 300 may decode the received shared contents based on the key value of the second device 300.

The server 100 may use location information, such as, GPS data, or WPS data, to regulate access to the shared contents. For example, the server 100 may provide access to the shared contents if the device requesting the shared contents meets a location condition, for example, the location condition may be that the second device 300 is located within a reference location or outside the reference location. For example, the server 100 may provide access to a reference document within a reference premise, such as, a company or business premise. A method for content sharing based on location may differ from the method of content shared described above with reference to FIG. 4 in the manner described. For example, but not limited thereto, in operation S1, the first device 200 may determine a location condition by which to provide access to a document. The location condition may be a reference distance from the first device 200 or a premise in which access to information may be provided. In operation S4, the generated third data may include location information. The location information may include a location of the first device 200, a location of the second device 300, a distance between the first device 200 and the second device 300, and the location condition by which access to information is regulated. For example, if the second device 300 is located within a reference distance from the first device, i.e., if the second device and the first device are separated by less than or equal to the reference distance, shared contents may be provided to the second device 300 if it connects to the first device 200 using NFC. In operation S6, the second device 300 may transmit location information and a key value to the server 100. In operation S10, the server 100 searches for shared contents which matches the DRM-associated condition and the location condition. In other words, it may be determined if the second device 300, which is requesting the shared contents, is located at a location in which access to the shared contents is permitted.

According to an exemplary embodiment, the second device 300 may be a smart TV displaying a movie and a third device may be a smart phone, tablet computer, etc. The second device 300 may have redistribution rights for the displayed movie from the first device 200. If the second device 300 has redistribution rights, the second device 300 may receive a request for shared contents information from the third device (e.g., smart phone) using NFC. The second device 300 may authorize the sharing of the movie content according to the received shared content. However, if the first device 200 does not grant redistribution rights to the second device 300, the second device 300 (smart TV) may not authorize the sharing of content with the third device (smart phone).

According to an exemplary embodiment, if NFC contact occurs between the first device and the second device, additional third data may be generated and transmitted by the first device without NFC from the second device. The server may generate and transmit a list of additional shared contents from the third data to the second device. The additional shared contents may be shared contents not previously designated as shared.

According to an exemplary embodiment, the second device may communicate with the server to request a list of contents on the server according to other devices and may then communicate with the first device to request shared contents of the first device using NFC. According to an exemplary embodiment, different operations may occur depending on the number of contacts made using NFC.

According to an exemplary embodiment, contents may be shared between devices with less user input, for example a single touch may signal the sharing of contents between devices. In addition, according to exemplary embodiments, the security of personal information shared by a device may be maintained, and the authority to use the shared contents may be adjusted. The shared contents may be transmitted in a format according to characteristics of a receiving terminal, and the sharing of content may be restricted according to distance or location.

The present disclosure relates to facilitating sharing of contents between terminals. In the present disclosure, a first device, which is allowed to access contents, may be provided by a content server, may share the contents' access authority with a second device. In the present disclosure, a password or key may be provided by a second device to a first device using a portable security module. The second device may be certified to access the shared contents based on the password or key, and information to access the contents may be transmitted to the certified second device. The present disclosure may simplify a content sharing procedure.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A content sharing system using near field communication (NFC) in a cloud network, comprising:
a server to store contents;
a first device having an authority to use the contents and to generate first data including a list of shared contents among the contents and digital rights management (DRM)-associated information; and
a second device to generate second data including a key value to identify the second device and to transmit the second data to the first device if the NFC is activated to share the shared contents,
wherein, in order to share the shared contents, the first device generates third data including the first data and the second data.

2. The content sharing system of claim 1, wherein the first device transmits the third data to the server, and the server encodes the shared contents satisfying the DRM-associated information with the key value in response to a request of the second device for the shared contents, and the server transmits the shared contents to the second device.

3. The content sharing system of claim 1, wherein the first device and the second device transmit and receive data to generate the second data if the first device and the second device are within a reference distance of each other, and, the first device generates the third data if the first device and the second device are separated more than the reference distance from each other.

4. The content sharing system of claim 2, wherein the first device transmits a universal resource locator (URL) of the server to the second device using the NFC, and the second device accesses the server based on the URL.

5. The content sharing system of claim 1, wherein the key value comprises at least one of an international mobile equipment identity (IMEI) and a mobile identification number (MIN).

6. The content sharing system of claim 2, wherein the second data comprises a profile including at least one of resolution and performance criteria of the second device, and the server encodes the shared contents satisfying the DRM-associated information according to the profile.

7. The content sharing system of claim 2, wherein the DRM-associated information comprises at least one of a validity of application of DRM to the shared contents, a subsequent sharing right, an effective sharing term, an allowable regeneration time, an allowable sharing time, and a shared contents related payment information.

8. The content sharing system of claim 7, wherein the third data comprises global positioning system (GPS) data, and the server receives GPS data from the second device and the server transmits the shared contents if the second device is within a reference distance from the first device according to the GPS data.

9. The content sharing system of claim 7, wherein the third data comprises GPS data, the server receives GPS data from the second device, and the server transmits the shared contents if the first device and the second device are separated by more than a reference distance according to the GPS data.

10. A content sharing method using near field communication (NFC) in a cloud network, comprising:
generating first data including a list of shared contents and digital rights management (DRM)-associated information in a first device;
generating second data including a key value in a second device, and transmitting the second data to the first device if near field communication (NFC) is activated; and
generating third data including the first data and the second data in the first device to share the shared contents.

11. The content sharing method of claim 10, further comprising:
transmitting, by the first device, the third data to a server;
requesting, by the second device, the shared contents from the server; and
encoding, by the server, the shared contents satisfying the DRM-associated information with the key value in response to the request, and
transmitting the encoded shared contents to the second device from the server.

12. The content sharing method of claim 10, wherein, in generating the second data, the NFC is activated if the first device and the second device are within a reference distance from each other, and
wherein, in generating the third data, the third data is generated if the first device and the second device are separated more than the reference distance from each other.

13. The content sharing method of claim 10,
wherein generating the first data includes transmitting a universal resource locator (URL) of the server to the second device using the NFC, and
wherein requesting the shared contents comprises accessing, by the second device, the server according to the URL.

14. The content sharing method of claim 10, wherein the key value comprises at least one of an international mobile equipment identity (IMEI) and a mobile identification number (MIN).

15. The content sharing method of claim 11,
wherein the second data comprises a profile including at least one of resolution and performance criteria of the second device, and
wherein the shared contents satisfying the DRM-associated information are encoded according to the profile.

16. The content sharing method of claim 11, wherein the DRM-associated information comprises at least one of a validity of application of DRM to the shared contents, a subsequent sharing right, an effective sharing term, an allowable regeneration time, an allowable sharing time, and a shared contents related payment information.

17. The content sharing method of claim 16,
wherein the first data comprises global positioning system (GPS) data,
wherein requesting of the shared contents comprises transmitting GPS data of the second device to the server, and
wherein in encoding of the shared contents, the shared contents are transmitted if the second device is within a reference distance from the first device according to the GPS data.

18. The content sharing method of claim 16,
wherein the first data comprises global positioning system (GPS) data,
wherein requesting of the shared contents comprises transmitting GPS data of the second device to the server, and
wherein, in said encoding of the shared contents, the shared contents are transmitted if the first device and the second device are separated by more than a reference distance from the first device according to the GPS data.

19. A terminal to share content using near field communication (NFC) in a cloud network; comprising:
a control unit to generate first data including a list of shared contents in a server, digital rights management (DRM)-associated information of the shared contents, and third data; and
a near field communication (NFC) unit to transmit data and to receive second data,
wherein the control unit generates the third data according to the first data and the second data and the NFC unit transmits the third data to the server.

20. The terminal of claim 19, wherein the second data is received if the terminal is separated less than or equal to a reference distance from a second terminal, and the third data is generated if the terminal and the second terminal are separated more than the reference distance from the second terminal.
